(19) United States
(12) Patent Application Publication
(10) Pub. No.: US 2026/0086595 A1
(43) Pub. Date: Mar. 26, 2026

(54) FORCE FEEDBACK APPARATUS AND ELECTRONIC DEVICE

(71) Applicant: VIVO MOBILE COMMUNICATION CO., LTD., Dongguan (CN)

(72) Inventors: Wanli HU, Dongguan (CN); Xu CHEN, Dongguan (CN); Jiantang LIN, Dongguan (CN)

(73) Assignee: VIVO MOBILE COMMUNICATION CO., LTD., Dongguan (CN)

(21) Appl. No.: 19/406,928

(22) Filed: Dec. 2, 2025

Related U.S. Application Data
(63) Continuation of application No. PCT/CN2024/097898, filed on Jun. 7, 2024.

(30) Foreign Application Priority Data
Jun. 13, 2023 (CN) 202310698734.0

(51) Int. Cl. G05G 5/03; G05G 1/015; G05G 1/04

(52) U.S. Cl. CPC G05G 5/03; G05G 1/015; G05G 1/04; G05G 2505/00

(57) ABSTRACT

A force feedback apparatus is provided. The force feedback apparatus includes a base, a trigger, a first transmission assembly, and a second transmission assembly. The trigger is rotatably connected to the base. The first transmission assembly is in a transmission-connection to the trigger. The second transmission assembly includes a first gear, a transmission gear, a ring gear, and a rotatable support. The transmission gear is meshed between the first gear and the ring gear. The ring gear is fixed to the base. The rotatable support is connected to the transmission gear. The rotatable support is rotatable relative to the first gear and the ring gear. The driving assembly can drive the second transmission end to rotate.

### CROSS-REFERENCE TO RELATED APPLICATIONS

This application is a continuation of International Application No. PCT/CN2024/097898, filed Jun. 7, 2024, which claims priority to Chinese Patent Application No. 202310698734.0, filed Jun. 13, 2023. The entire contents of each of the above-referenced applications are expressly incorporated herein by reference.

### TECHNICAL FIELD

This application relates to the technical field of electronic devices, and specifically, to a force feedback apparatus and an electronic device.

### BACKGROUND

As science and technology develop, electronic devices have increasingly abundant functions. Electronic devices become one of essential tools in a plurality of types of social life of people, such as daily travel, entertainment, and communication. In the related art, to enhance physical touch during operation of an electronic device by a user, a vibration mechanism is arranged in the electronic device. The electronic device vibrates through the vibration mechanism, so that the user can obtain tactile feedback. The vibration mechanism can only drive the entire electronic device to vibrate, and cannot provide precise tactile feedback to a trigger pressed by a user.

Due to the foregoing problem, the vibration mechanism in the related art cannot provide precise tactile feedback to a trigger pressed by a user.

### SUMMARY

This application is intended to provide a force feedback apparatus and an electronic device.

According to a first aspect, an embodiment of this application provides a force feedback apparatus, including:

a base;

a trigger, rotatably connected to the base;

a first transmission assembly, in a transmission-connection to the trigger;

a second transmission assembly, including a first gear, a transmission gear, a ring gear, and a rotatable support, where the transmission gear is meshed between the first gear and the ring gear, the ring gear is fixed to the base, the rotatable support is connected to the transmission gear, the rotatable support is rotatable relative to the first gear and the ring gear, one of the rotatable support and the first gear is a first transmission end of the second transmission assembly, the other is a second transmission end of the second transmission assembly, and the first transmission end is in a transmission-connection to the first transmission assembly; and

a driving assembly, in a transmission-connection to the second transmission end, where the driving assembly is configured to drive the second transmission end to rotate.

In a case that the trigger rotates relative to the base, the trigger is configured to drive, through the first transmission assembly, the first transmission end to rotate, and the driving assembly is configured to drive the second transmission end to rotate, to block or assist in the rotation of the first transmission end.

According to a second aspect, an embodiment of this application provides an electronic device, including any force feedback apparatus provided in the first aspect.

In embodiments of this application, the first transmission assembly and the second transmission assembly are in a transmission-connection between the trigger and the driving assembly, so that the first transmission assembly and the second transmission assembly can transmit power between the trigger and the driving assembly; and the driving assembly is configured to drive the second transmission end to rotate to block or assist in the rotation of the first transmission end, so that the driving assembly can assist in or block the rotation of the trigger relative to the base through the first transmission assembly and the second transmission assembly, and therefore the trigger can implement tactile feedback such as damping, force release, vibration, and rebound. The tactile feedback is precisely fed back to a user through the trigger, which improves a real sense and accuracy of the tactile feedback.

Other aspects and advantages of this application are provided in the following description, some of which become apparent from the following description or may be learned from practices of this application.

### BRIEF DESCRIPTION OF THE DRAWINGS

To describe technical solutions in embodiments of this application or in the related art more clearly, drawings required for describing embodiments or the related art are briefly described below. Apparently, the drawings in the following description show some embodiments of this application, and a person of ordinary skill in the art may still derive other drawings from these drawings without creative efforts.

The foregoing and/or additional aspects and advantages of this application become apparent and comprehensible in the description of embodiments made with reference to the following drawings.

FIG. 1 is a first three-dimensional schematic structural diagram of an embodiment of a force feedback apparatus according to this application;

FIG. 2 is a second three-dimensional schematic structural diagram of an embodiment of a force feedback apparatus according to this application;

FIG. 3 is a schematic cross-sectional structural view of an embodiment of a force feedback apparatus according to this application;

FIG. 4 is a schematic exploded structural view of an embodiment of a second transmission assembly according to this application;

FIG. 5 is a third three-dimensional schematic structural diagram of an embodiment of a force feedback apparatus according to this application;

FIG. 6 is a fourth three-dimensional schematic structural diagram of an embodiment of a force feedback apparatus according to this application;

FIG. 7 is a schematic cross-sectional structural view of an embodiment of a force feedback apparatus according to this application;

FIG. 8 is a first schematic exploded structural view of an embodiment of a force feedback apparatus according to this application;

FIG. 9 is a schematic cross-sectional structural view of an embodiment of a second transmission assembly according to this application; and

FIG. 10 is a second schematic exploded structural view of an embodiment of a force feedback apparatus according to this application.

### DETAILED DESCRIPTION

To make objectives, technical solutions, and advantages of embodiments of this application clearer, the technical solutions in embodiments of this application are described below with reference to the drawings in embodiments of the present disclosure. Apparently, the described embodiments are merely some rather than all of embodiments of this application. All other embodiments obtained by a person of ordinary skill in the art based on embodiments of this application without making creative efforts shall fall within the protection scope of this application.

Features defined by the terms "first" and "second" in the specification and the claims of this application may explicitly or implicitly include one or more of these features. In the description of this application, unless otherwise stated, "a plurality of" means two or more. In addition, in the specification and the claims, "and/or" indicates at least one of connected objects, and the character "/" generally indicates an "or" relationship between associated objects.

In the description of this application, it should be understood that orientation or position relationships indicated by the terms such as "center", "longitudinal", "transverse", "length", "width", "thickness", "on", "below", "front", "back", "left", "right", "vertical", "horizontal", "top", "bottom", "inside", "outside", "clockwise", "anticlockwise", "axial direction", "radial direction", and "circumferential direction" are based on orientation or position relationships shown in the drawings, and are merely used to facilitate description of this application and simplify the description, rather than indicating or implying that the mentioned apparatus or element needs to have a particular orientation or be constructed and operated in a particular orientation. Therefore, such terms cannot be understood as a limitation on this application.

In the description of this application, it should be noted that unless otherwise explicitly specified or defined, the terms "mount", "connect", and "connection" should be understood in a broad sense. For example, the connection may be a fixed connection, a detachable connection, or an integral connection; or the connection may be a mechanical connection or an electrical connection; or the connection may be a direct connection, an indirect connection through an intermediary, or internal communication between two components. A person of ordinary skill in the art may understand the specific meanings of the foregoing terms in this application according to specific situations.

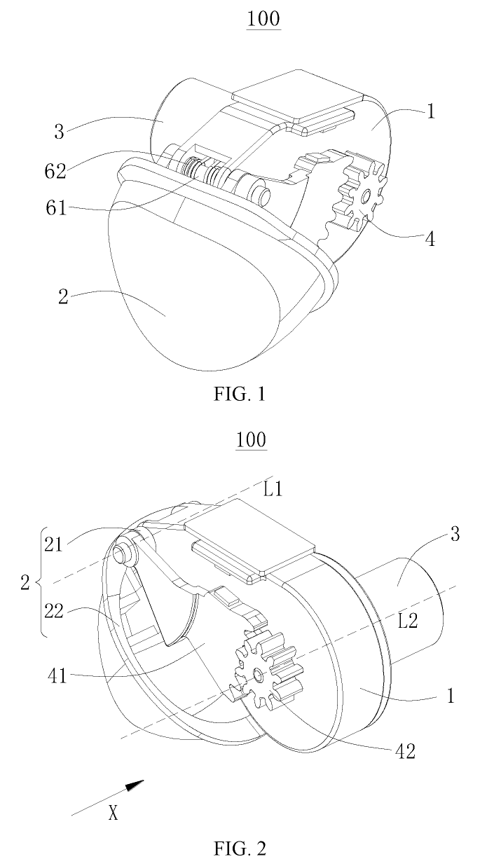

A force feedback apparatus 100 in embodiments of this application is described in detail below with reference to FIG. 1 to FIG. 10.

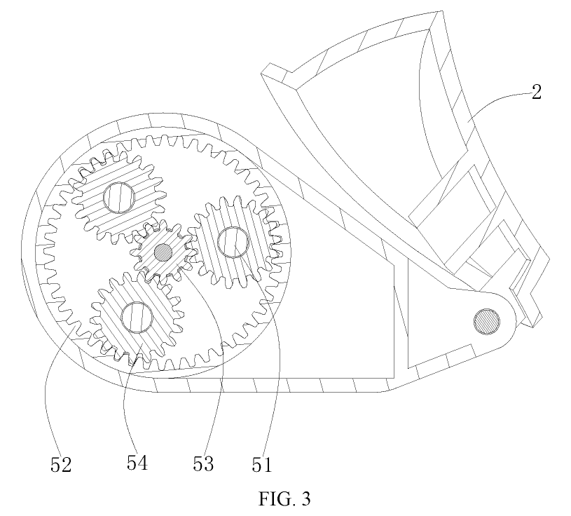

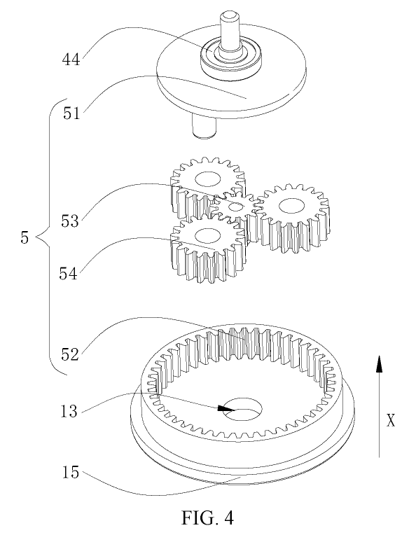

As shown in FIG. 1, FIG. 2, FIG. 3, and FIG. 4, a force feedback apparatus 100 includes a base 1, a trigger 2, a first transmission assembly 4, a second transmission assembly 5, and a driving assembly 3. The trigger 2 is rotatably connected to the base 1. The first transmission assembly 4 is in a transmission-connection to the trigger 2. The second transmission assembly 5 includes a first gear 53, a transmission gear 54, a ring gear 52, and a rotatable support 51. The transmission gear 54 is meshed between the first gear 53 and the ring gear 52. The ring gear 52 is fixed to the base 1. The rotatable support 51 is connected to the transmission gear 54. The rotatable support 51 can rotate relative to the first gear 53 and the ring gear 52. One of the rotatable support 51 and the first gear 53 is a first transmission end of the second transmission assembly 5. The other of the rotatable support 51 and the first gear 53 is a second transmission end of the second transmission assembly 5. The first transmission end is in a transmission-connection to the first transmission assembly 4. The driving assembly 3 is in a transmission-connection to the second transmission end. The driving assembly 3 can drive the second transmission end to rotate. In a case that the trigger 2 rotates relative to the base 1, the trigger 2 can drive, through the first transmission assembly 4, the first transmission end to rotate, and the driving assembly 3 can drive the second transmission end to rotate, to block or assist in the rotation of the first transmission end.

The force feedback apparatus 100 provided in this application may be arranged in an electronic device. The electronic device may be a handle, a remote control, or the like configured to interact with another electronic device, or may be a device such as a mobile phone, a tablet computer, a notebook computer, a palmtop computer, an on-board electronic device, an augmented reality (AR)/virtual reality (VR) device, or an electronic game console. A specific type of the electronic device is not limited in this embodiment of this application. For ease of description, an example in which the force feedback apparatus 100 is applied to a handle is used below for description.

The base 1 may provide a mounting basis for the trigger 2 and the driving assembly 3, and may further provide an accommodating space for the first transmission assembly 4 and/or the second transmission assembly 5, to accommodate at least a portion of the first transmission assembly 4 and/or at least a portion of the second transmission assembly 5. For example, the first gear 53, the transmission gear 54, the ring gear 52, and the rotatable support 51 may be accommodated in the base 1 together.

At least a portion of the trigger 2 is exposed from a housing of the handle, so that a user may touch the trigger 2 and apply a force to the trigger 2. The trigger 2 is rotatably connected to the base 1, so that the user may apply a force to the trigger 2 and push the trigger 2 to rotate relative to the base 1, and therefore the trigger 2 turns to rotate relative to the base 1 between a first position and a second position.

The trigger 2, the first transmission assembly 4, the second transmission assembly 5, and the driving assembly 3 are sequentially connected. When the trigger 2 rotates in the first position and the second position, the trigger 2 can drive the first transmission assembly 4 to move, and the first transmission assembly 4 can drive the second transmission assembly 5 to move. The driving assembly 3 may output power to the second transmission assembly 5, so that the second transmission assembly 5 moves, the second transmission assembly 5 drives the first transmission assembly 4 to move, and the first transmission assembly 4 drives or limits rotation of the trigger 2 in the first position and the second position.

The first transmission assembly 4 may include one or more of a transmission bar, a gear, a worm, a transmission belt, or a chain, to transmit power of the trigger 2 to the second transmission assembly 5, or to transmit power of the second transmission assembly 5 to the trigger 2.

The transmission gear 54 may revolve around the first gear 53, and the transmission gear 54 also rotates. In this embodiment provided in this application, the second transmission assembly 5 has a first transmission end and a second transmission end, and the second transmission assembly 5 can provide at least the following two transmission-connection manners:

First, the rotatable support 51 is the first transmission end, and the first gear 53 is the second transmission end. The rotatable support 51 is in a transmission-connection to the first transmission assembly 4, and the first gear 53 is in a transmission-connection to the driving assembly 3. In a case that the driving assembly 3 outputs power to the second transmission end, a driving shaft of the driving assembly 3 drives the first gear 53 to rotate, and the first gear 53 drives the transmission gear 54 meshed with the first gear to rotate about a central axis of the first gear 53. Because the ring gear 52 is fixed to the base 1, the ring gear 52 does not rotate with the transmission gear 54. The transmission gear 54 drives the rotatable support 51 to rotate, and the rotatable support 51 outputs power to the first transmission assembly 4. A transmission direction in which the first transmission assembly 4 outputs the power to the first transmission end is opposite to a transmission direction in which the driving assembly 3 outputs the power to the second transmission end. Details are not described herein.

Second, the first gear 53 is the first transmission end, and the rotatable support 51 is the second transmission end. The first gear 53 is in a transmission-connection to the first transmission assembly 4, and the rotatable support 51 is in a transmission-connection to the driving assembly 3. In a case that the driving assembly 3 outputs power to the second transmission end, the driving shaft of the driving assembly 3 drives the rotatable support 51 to rotate, and the rotatable support 51 drives the transmission gear 54 connected to the rotatable support to rotate about the central axis of the first gear 53. Because the ring gear 52 is fixed to the base 1, the ring gear 52 does not rotate with the transmission gear 54. The transmission gear 54 drives the first gear 53 to rotate, and the first gear 53 outputs power to the driving assembly 3. A transmission direction in which the first transmission assembly 4 outputs the power to the first transmission end is opposite to a transmission direction in which the driving assembly 3 outputs the power to the second transmission end. Details are not described herein.

The driving assembly 3 may include a driving member such as a rotary motor or a linear motor. The driving assembly 3 may directly or indirectly output power in forward and reverse directions to the second transmission assembly 5 through the driving member. When the direction of the power outputted by the driving assembly 3 is the same as a direction in which the trigger 2 drives, through the first transmission assembly 4, the second transmission end to rotate, the power outputted by the driving assembly 3 assists in the rotation of the second transmission end. When the direction of the power outputted by the driving assembly 3 is opposite to the direction in which the trigger 2 drives, through the first transmission assembly 4, the second transmission end to rotate, the power outputted by the driving assembly 3 blocks the rotation of the second transmission end. Parameters such as an action direction of the power outputted by the driving assembly 3, a torque magnitude of the power, and an output duration of the power may be adjusted, to implement tactile feedback such as press damping, force release, vibration, and rebound.

In the force feedback apparatus 100 provided in this embodiment, the first transmission assembly 4 and the second transmission assembly 5 are in a transmission-connection between the trigger 2 and the driving assembly 3, so that the first transmission assembly 4 and the second transmission assembly 5 can transmit power between the trigger 2 and the driving assembly 3. The transmission gear 54 is meshed between the first gear 53 and the ring gear 52, and the rotatable support 51 is connected to the transmission gear 54, so that a transmission ratio of the second transmission assembly 5 may be adjusted through adjustment of a quantity of teeth of the transmission gear 54, the first gear 53, and the ring gear 52. Therefore the force feedback apparatus 100 can implement force feedback responses with different precisions. The driving assembly 3 is configured to drive the second transmission end to rotate to block or assist in the rotation of the first transmission end, so that the driving assembly 3 can assist in or block the rotation of the trigger 2 relative to the base 1 through the first transmission assembly 4 and the second transmission assembly 5. Therefore the trigger 2 can implement tactile feedback such as damping, force release, vibration, and rebound. The tactile feedback is precisely fed back to the user through the trigger 2, which improves a real sense and accuracy of the tactile feedback.

In a case that the ring gear 52 is fixed, the first gear 53 is a power input end, and the rotatable support 51 is a power output end, the transmission ratio of the second transmission assembly 5 is greater than 1, and a rotational speed of the power input end of the second transmission assembly 5 is greater than a rotational speed of the power output end, so that the second transmission assembly 5 moves to reduce a speed and increase a torque. In a case that the ring gear 52 is fixed, the rotatable support 51 is a power input end, and the first gear 53 is a power output end, the transmission ratio of the second transmission assembly 5 is less than 1, and the rotational speed of the power input end of the second transmission assembly 5 is less than the rotational speed of the power output end, so that the second transmission assembly 5 moves to increase a speed and reduce a torque. Therefore, a person skilled in the art may determine, based on a demand for increasing or reducing the rotational speed outputted by the driving assembly 3 and a demand for increasing or reducing the torque outputted by the driving assembly 3, whether to connect the driving assembly 3 to the rotatable support 51 or the ring gear 52.

In some embodiments, the first transmission end is the rotatable support 51, the second transmission end is the first gear 53, and the first transmission assembly 4, the rotatable support 51, the first gear 53, and the driving assembly 3 are sequentially arranged along a first direction X.

Because the rotatable support 51 is connected to the first transmission assembly 4, and the first gear 53 is connected to the driving assembly 3, a torque inputted by the driving mechanism through the first gear 53 can be increased through the second transmission assembly 5, so as to increase a torque that can be exerted by the driving assembly 3 on the trigger 2 through the first transmission assembly 4 and the second transmission assembly 5 while maintaining a maximum output torque of the driving assembly 3 unchanged.

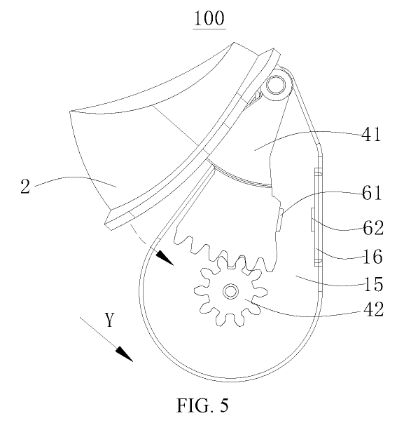

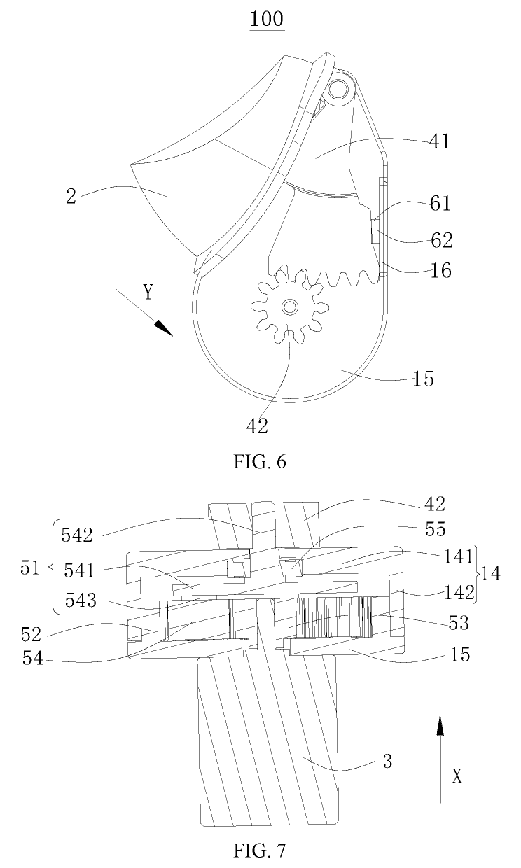

FIG. 5 is a three-dimensional schematic structural diagram of the force feedback apparatus 100 with the trigger 2 being in the first position, and FIG. 6 is a three-dimensional schematic structural diagram of the force feedback apparatus 100 with the trigger 2 being in the second position. For example, the first position is an initial position of the trigger 2 relative to the base 1, and the second position is a pressed position of the trigger 2 relative to the base 1.

For example, as shown in FIG. 2 and FIG. 5, the user presses the trigger 2, so that the trigger 2 rotates from the first position to the second position along a direction indicated by a dashed-line arrow shown in FIG. 5. The trigger 2 and the base 1 rotate about an axis L1 shown in FIG. 2. Driven by the trigger 2, the rotatable support 51 rotates about an axis L2 shown in FIG. 2. The rotatable support 51 drives the transmission gear 54 to rotate while revolving around the first gear 53. The transmission gear 54 inputs, to the first gear 53, a driving force for driving the first gear 53 to rotate along a first circumferential direction. In a case that the driving assembly 3 outputs, to the first gear 53, the driving force for driving rotation along the first circumferential direction, the driving assembly 3 can assist in the rotation of the first gear 53 along the first circumferential direction, so that the user senses tactile feedback of force release, that is, tactile feedback of unlaborious pressing of the trigger 2. The first circumferential direction is opposite to a second circumferential direction. In a case that the driving assembly 3 outputs, to the first gear 53, the driving force driving rotation along the second circumferential direction, the driving assembly 3 can block the rotation of first gear 53 along the first circumferential direction, so that the user feels tactile feedback of pressing damping, that is, tactile feedback of laborious pressing of the trigger 2.

For example, as shown in FIG. 6, the user presses the trigger 2, and the trigger 2 is in the second position. In a case that the driving assembly 3 outputs, to the first gear 53, the driving force for driving rotation along the second circumferential direction, the driving assembly 3 drives the first gear 53 to rotate along the second circumferential direction, the first gear 53 drives the transmission gear 54 to rotate while revolving around the first gear 53, the transmission gear 54 drives the rotatable support 51 to rotate, the rotatable support 51 outputs power to the first transmission assembly 4, and the first transmission assembly 4 can drive the trigger 2 to rotate from the second position to the first position, so that the user senses tactile feedback of rebound of the trigger 2 rebounds. That is, the trigger 2 returns to the initial position.

For example, the user gently touches the trigger 2. In a case that the driving assembly 3 outputs, to the first gear 53, a driving force for driving rotation back and forth along the first circumferential direction and the second circumferential direction, the driving assembly 3 drives the first gear 53 to rotate back and forth along the first circumferential direction and the second circumferential direction, the first gear 53 drives the transmission gear 54 to rotate while revolving around the first gear 53, the transmission gear 54 drives the rotatable support 51 to rotate. The rotatable support 51 outputs, to the first transmission assembly 4, power for rotation back and forth along the first circumferential direction and the second circumferential direction, and the first transmission assembly 4 can drive the trigger 2 to rotate back and forth between the first position and the second position, so that the user feels tactile feedback of vibration of the trigger 2.

In this embodiment provided in this application, the first transmission assembly 4, the rotatable support 51, the first gear 53, and the driving assembly 3 are sequentially arranged along the first direction X. In a case that the trigger 2 moves or the driving mechanism drives, the rotatable support 51 and the first gear 53 rotate, and the transmission gear 54 revolves around the first gear 53 while rotating, so that the first transmission assembly 4 does not move in the first direction X. That is, power transmission can be implemented, thereby omitting reserving a movement space for the second transmission assembly 5 in the first direction X, and reducing a length of the force feedback apparatus 100 in the first direction X.

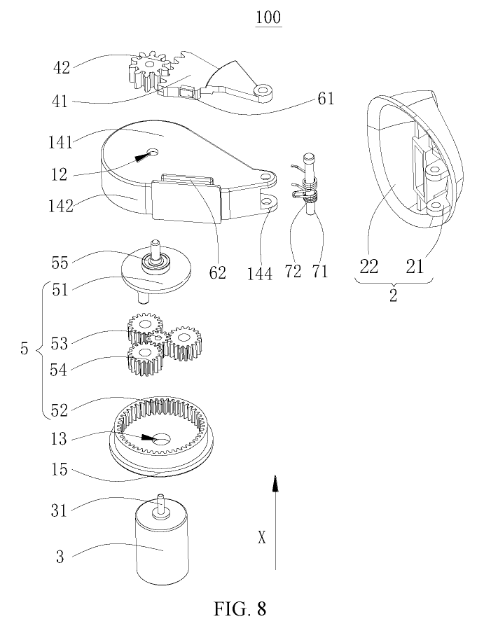

Referring to FIG. 7 and FIG. 8, in some embodiments, the base 1 has a first opening 12 and a second opening 13 provided along the first direction X. The second transmission assembly 5 is arranged in the base 1. A portion of the rotatable support 51 extends out of the base 1 through the first opening 12 and is connected to the first transmission assembly 4. A portion of the driving assembly 3 extends into the base 1 through the second opening 13 and is connected to the first gear 53.

The first transmission assembly 4 may be arranged on a side of the base 1 along the first direction X, and the driving assembly 3 may be arranged on another side of the base 1 along the first direction X. The base 1 can provide an accommodating space for accommodating the ring gear 52, the first gear 53, and the transmission gear 54, can confine, in the base 1, a lube used to lube the ring gear 52, the first gear 53, and the transmission gear 54, and can provide a mounting basis for the ring gear 52, the rotatable support 51, and the driving assembly 3.

The ring gear 52, the first gear 53, and the transmission gear 54 are arranged in the base 1, to prevent impurities and the like from entering the base 1 and interfering with cooperative movement among the ring gear 52, the first gear 53, and the transmission gear 54.

In some embodiments, the base 1 includes a first cover 14 and a second cover 15 that are combined, the first opening 12 is provided on the first cover 14, the second opening 13 is provided on the second cover 15, and the ring gear 52 is fixed to the first cover 14 and/or the second cover 15.

The first cover 14 and the second cover 15 are combined with each other, and the first cover 14 and the second cover 15 jointly define an accommodating space. The ring gear 52 is fixed to the first cover 14 and/or the second cover 15, to prevent the ring gear 52 from being fixed to the first cover 14 and/or the second cover 15 from rotating during rotation of the transmission gear 54. In the embodiment shown in FIG. 8, the ring gear 52 is fixed to the second cover 15, and the ring gear 52 and the second cover 15 are an integrally formed piece, to increase connection stability between the ring gear 52 and the second cover 15.

In some embodiments, the ring gear 52 is fixed to the second cover 15. The first cover 14 includes a cover plate 141 and a side plate 142, the side plate 142 is arranged on the cover plate 141, the side plate 142 is arranged around the ring gear 52, and the second cover 15 covers the side plate 142.

An inner gear surface of the ring gear 52 is meshed with the transmission gear 54, and an outer surface of the ring gear 52 is arranged opposite to the side plate 142. During assembly, the first gear 53, the transmission gear 54, the rotatable support 51, and the ring gear 52 on the second cover 15 may be first assembled, and then the first cover 14 is combined with the second cover 15, so that a portion of the rotatable support 51 extends out of the first opening 12.

The side plate 142 is arranged around the ring gear 52, so that the side plate 142 can protect the ring gear 52, thereby reducing or preventing damage on the ring gear 52 from an external force, and improving movement stability of the second transmission assembly 5.

In some embodiments, the rotatable support 51 includes a mounting plate 541, a first connection bar 542, and a second connection bar 543. The mounting plate 541 includes two sides along a first direction X. The first connection bar 542 and the second connection bar 543 are connected to the two sides. The first connection bar 542 extends out of the base 1 and is connected to the first transmission assembly 4. The second connection bar 543 is connected to the transmission gear 54.

The first connection bar 542 and the second connection bar 543 are arranged on the mounting plate 541, so that power can be transmitted between the second gear 42 and the transmission gear 54 through the rotatable support 51.

In some embodiments, a plurality of transmission gears 54 are arranged. The plurality of transmission gears 54 are arranged around the first gear 53, and the rotatable support 51 is respectively connected to the plurality of transmission gears 54.

In a case that a plurality of transmission gears 54 are arranged, a plurality of second connection bars 543 are also arranged. The plurality of second connection bars 543 are connected to the plurality of transmission gears 54 in one-to-one correspondence. A larger quantity of the transmission gear 54 indicates a larger load the second transmission assembly 5 can bear. The plurality of transmission gears 54 may share a load, to reduce an action force of each transmission gear 54 and each second connection bar 543, and reduce a size of the transmission gear 54.

To balance a radial force component at each meshed position of the transmission gear 54 with a centripetal force generated from the revolution of the transmission gear 54, the plurality of transmission gears 54 may be arranged around the first gear 53 at uniform intervals, to increase stability of the rotation and the revolution of the transmission gear 54. In the embodiment shown in FIG. 8, three transmission gears 54 are arranged, and the three transmission gears 54 are uniformly arranged around the first gear 53. The first connection bar 542 is arranged coaxially with the first gear 53, and projections of the three second connection bars 543 on the mounting plate 541 are arranged around a projection of the first connection bar 542 on the mounting plate 541.

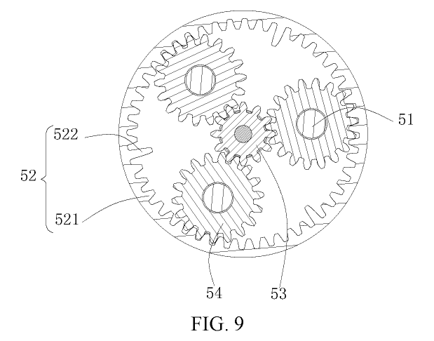

Referring to FIG. 9, in some embodiments, to help the user press the trigger 2, a travel of the trigger 2 from the first position to the second position is relatively short, so that a travel by which the transmission gear 54 revolves around the first gear 53 is less than a circumference of the first gear 53 when the trigger 2 rotates from the first position to the second position. In other words, during the rotation of the trigger 2 between the first position and the second position, the transmission gear 54 does not need to revolve around the first gear 53 in an entire circle. Therefore, in some embodiments, the ring gear 52 includes a plurality of arc-shaped racks 521 and limiting pieces 522 arranged on two ends of the arc-shaped racks 521. The plurality of arc-shaped racks 521 are sequentially arranged around the first gear 53 at intervals, and the plurality of transmission gears 54 are meshed with the plurality of arc-shaped racks 521 in one-to-one correspondence.

The limiting pieces 522 may be bumps close to the first gear 53 along a radial direction of the ring gear 52 relative to the arc-shaped pieces. Two limiting pieces 522 located between two arc-shaped racks 521 may be an integrally formed piece. The arc-shaped racks 521 and the limiting pieces 522 are alternately arranged around the first gear 53.

The limiting pieces 522 can limit the revolution travel of each transmission gear 54 and ensure a consistent length of the arc-shaped racks 521 engaged with the transmission gears 54, thereby restricting the revolution travel of the transmission gear 54 and a rotation angle of the trigger 2 relative to the base 1.

For example, when the trigger 2 is in the first position relative to the base 1, each transmission gear 54 contacts a limiting piece 522 located on one end of an arc-shaped rack 521. When the trigger 2 is in the second position relative to the base 1, each transmission gear 54 contacts a limiting piece 522 located on another end of the arc-shaped rack 521. Through the arrangement of the limiting pieces 522, the trigger 2 can be prevented from rotating beyond the first position or the second position relative to the base 1. The arc-shaped racks 521 may have a same length.

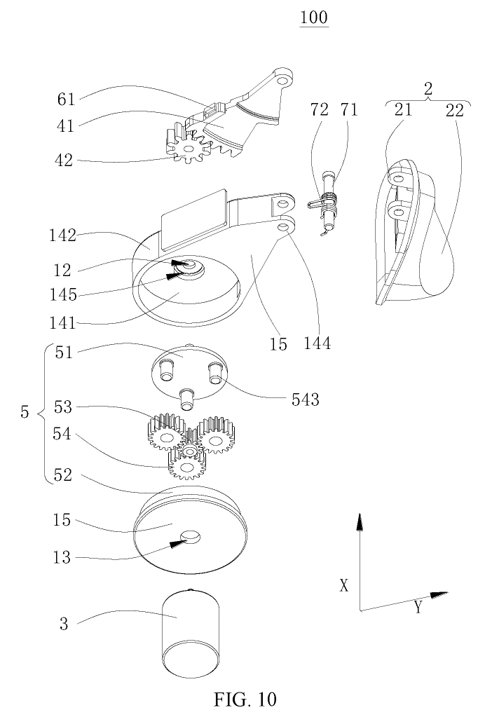

Referring to FIG. 8 and FIG. 10, in some embodiments, the second transmission assembly 5 further includes a bearing 55. The bearing 55 is arranged between the rotatable support 51 and the base 1.

The bearing 55 arranged between the rotatable support 51 and the base 1 can reduce friction between the rotatable support 51 and the base 1. In some embodiments, the bearing 55 is arranged between the first connection bar 542 and the first cover 14. An avoidance recess 145 may be provided on the cover plate 141 of the first cover 14. The bearing 55 may be placed in the avoidance recess 145. The avoidance recess 145 can limit the bearing 55. In addition, the avoidance recess 145 receives at least part of the bearing 55, to improve assembly compactness of the second transmission assembly 5 and the base 1.

In some embodiments, the first transmission assembly 4 includes a swinging arm 41 and a second gear 42. One end of the swinging arm 41 is rotatably connected to the trigger 2, and the trigger 2 can drive the swinging arm 41 to rotate relative to the base 1. The second gear 42 is connected to the rotatable support 51 and is meshed with the swinging arm 41. The second gear 42, the second transmission assembly 5, and the driving assembly 3 are sequentially connected along the first direction X. The second transmission assembly 5 and the trigger 2 are spaced apart along the second direction Y. The first direction X intersects the second direction Y.

One end of the swinging arm 41 and the trigger 2 may be an integrally formed structure. When the trigger 2 rotates at a specific angular velocity, the swinging arm 41 can rotate together at the same angular velocity. Another end of the swinging arm 41 has meshing teeth for meshing with the second gear 42. In a case that the swinging arm 41 rotates, the swinging arm 41 can push the second gear 42 to rotate. A rotation force generated from the rotation of the second gear 42 is inputted to the first rotation end, to drive a second rotation end to rotate.

In this embodiment, the swinging arm 41 and the second gear 42 are arranged, so that the rotation of the trigger 2 can be transmitted to the second transmission assembly 5; and a teeth quantity of the second transmission assembly 5 may be set to adjust a transmission ratio of the first rotation end and the second rotation end, thereby improving precision of a force feedback provided by the driving assembly 3 through the first transmission assembly 4 and the second transmission assembly 5 for the rotation of the trigger 2. The second transmission assembly 5 and the trigger 2 are spaced apart along the second direction Y, to reduce a length of the force feedback apparatus 100 in the first direction X.

In some embodiments, the trigger 2 rotates about the first axis L between the first position and the second position. The trigger 2 drives the swinging arm 41 to rotate about the first axis L and translate in a reference plane. The first axis L extends along the first direction X. The second gear 42, the rotatable support 51, the ring gear 52, and the first ring gear 52 are coaxially arranged along the axis L2 shown in FIG. 2. The first direction X and the second direction Y are vertically arranged, and the reference plane may be arranged along the first direction X with the base 1.

In some embodiments, the force feedback apparatus 100 further includes a detection mechanism 6 and a control mechanism. The detection mechanism 6 includes a first sensor 61 and a second sensor 62. One of the first sensor 61 and the second sensor 62 is arranged on the first transmission assembly 4, and the other is arranged on the base 1. In a case that the trigger 2 rotates relative to the base 1 between the first position and the second position, the first sensor 61 moves away from or approaches the second sensor 62, and the first sensor 61 can generate relative position information of the first sensor 61 and the second sensor 62. The control mechanism is respectively electrically connected to the driving assembly 3 and the first sensor 61. The control mechanism can control, based on the relative position information, the driving assembly 3 to drive the second transmission end to rotate.

The first sensor 61 and the second sensor 62 are arranged, so that a distance between the first sensor 61 and the second sensor 62 can be detected, which is equivalent to a relative positional relationship between the trigger 2 and the base 1. One of the first sensor 61 and the second sensor 62 may be a magnetic piece, and the other may be a Hall element.

The relative position information may be an analog signal or a digital signal. The control mechanism includes a control chip. The detection mechanism 6 may be electrically connected to the control chip, to send the detected analog signal or digital signal to the control chip. The control chip may generate, based on the analog signal or the digital signal, a control signal for controlling the driving assembly 3, and the driving assembly 3 outputs power with different magnitudes in different directions based on the control signal. In this way, the driving assembly 3 can output power with different magnitudes in different directions based on different relative positions of the trigger 2 and the base 1.

An electronic device of a different specification needs to be equipped with a trigger 2 with a different profile. Therefore, the first sensor 61 is arranged on the swinging arm 41, to help equip the force feedback apparatus 100 with a trigger 2 of a different specification. Because the trigger 2 needs to be exposed from a housing of the electronic device and receives a pushing force applied by the user, the swinging arm 41 has better stability than the trigger 2. The first sensor 61 is arranged on the swinging arm 41, to improve stability of the first sensor 61.

In some embodiments, the force feedback apparatus 100 further includes a rotation shaft 71 and a return spring 73. The trigger 2, the base 1, and the return spring 73 are all sleeved on the rotation shaft 71. The return spring 73 abuts against a position between the base 1 and the trigger 2.

In a process in which the user applies a force to press the trigger 2 for rotation relative to the base 1, the return spring 73 deforms under the action of the base 1 and the trigger 2. When the user releases the trigger 2, an elastic restoring force of the return spring 73 drives relative rotation of the base 1 and the trigger 2 for returning.

For example, the first position is an initial position of the trigger 2 relative to the base 1, and the second position is a pressed position of the trigger 2 relative to the base 1. The user presses the trigger 2, so that the trigger 2 rotates from the first position toward the second position, and the trigger 2 and the base 1 squeeze the return spring 73 into deformation. The user releases the trigger 2, so that the elastic restoring force of the return spring 73 drives the base 1 and the trigger 2 to rotate from the second position toward the first position.

The trigger 2, the base 1, and the return spring 73 are all sleeved on the rotation shaft 71, to ensure that the trigger 2 and the base 1 can rotate relative to each other about an axial direction of the rotation shaft 71. The return spring 73 is arranged to abut against a position between the base 1 and the trigger 2, so that the trigger 2 can automatically return from the first position to the second position or automatically return from the second position to the first position without being pressed by the user.

In some embodiments, the trigger 2 includes a main body 22 and first rotary portions 21 that are connected. The first rotary portions 21 that are spaced apart are sleeved on the rotation shaft 71. The base 1 includes a side plate 142 and second rotary portions 144 that are connected. The second rotary portions 144 that are spaced apart are sleeved on the rotation shaft 71. The return spring 73 abuts against a position between the main body 22 and the side plate 142.

During the rotation of the first rotary portions 21 and the second rotary portions 144 about the rotation shaft 71, the main body 22 and the side plate 142 approach each other, so that the return spring 73 abutting against a position between the main body 22 and the side plate 142 can be compressed by the main body 22 and the side plate 142.

The first rotary portions 21 and the second rotary portions 144 may have a through hole, and the rotation shaft 71 may be inserted into the through hole along the first direction X. The first cover 14 of the base 1 includes a side plate 142 and a cover plate 141 and a connection plate that are spaced apart along the first direction X. The side plate 142 is connected to the cover plate 141 and the connection plate. Areas on the cover plate 141 and the connection plate having the through holes are reused as the second rotary portions 144 that are spaced apart.

In some embodiments, the base 1 includes a protrusion. The protrusion protrudes relative to the first cover 14 in a direction facing away from the driving assembly 3. The protrusion is arranged opposite to the swinging arm 41. The first sensor 61 is arranged on a side of the swinging arm 41 close to the protrusion, and the second sensor 62 is arranged on the protrusion. Because the second sensor 62 is arranged on the protrusion, the mounting base can avoid movement of the swinging arm 41. In some embodiments, the mounting base has a first surface, and the protrusion is arranged to protrude relative to the first surface. The swinging arm 41 may rotate in a reference plane on which the first surface is located.

In some embodiments, the force feedback apparatus 100 has at least one of a first operating mode, a second operating mode, or a third operating mode.

In a case that the force feedback apparatus 100 is in the first operating mode, the driving assembly 3 drives the second transmission end to rotate, so that the trigger 2 rotates back and forth relative to the base 1 between the first position and the second position.

In a case that the force feedback apparatus 100 is in the second operating mode and the trigger 2 rotates between the first position and the second position relative to the base 1, the trigger 2 drives, through the first transmission assembly 4, the first transmission end to rotate along the first circumferential direction, and the driving assembly 3 drives the second transmission end to rotate along the first circumferential direction.

In a case that the force feedback apparatus 100 is in the third operating mode and the trigger 2 rotates between the first position and the second position relative to the base 1, the trigger 2 drives, through the first transmission assembly 4, the first transmission end to rotate along the first circumferential direction, and the driving assembly 3 drives the second transmission end to rotate along the second circumferential direction.

The first circumferential direction and the second circumferential direction are opposite directions.

The first operating mode may be a vibration mode. The driving assembly 3 drives the second transmission end to rotate back and forth along a counterclockwise direction and a clockwise direction, and performs transmission through the first transmission assembly 4 and the second transmission assembly 5. The trigger 2 rotates back and forth between the first position and the second position relative to the base 1, so that the user senses vibration of the trigger 2.

The second operating mode may be a force release mode. In a process in which the user presses the trigger 2 for rotation, the second transmission end rotates along the first circumferential direction, and the driving assembly 3 drives the second transmission end to rotate along the first circumferential direction, so that the user senses force release when pressing of the trigger 2.

The second operating mode may be a rebound mode. The user presses and then releases the trigger 2, the driving assembly 3 drives the second transmission end to rotate along the first circumferential direction or the second circumferential direction, and the trigger 2 rotates relative to the base 1 under the action of the first transmission assembly 4, so that the user senses rebound of the trigger 2 to an initial position.

The second operating mode may be a damping mode. In a process in which the user presses the trigger 2 for rotation, the second transmission end rotates along the first circumferential direction, and the driving assembly 3 drives the second transmission end to rotate along the second circumferential direction, so that the user needs to apply a larger force to the trigger 2.

The force feedback apparatus 100 may further have initialization wear. When the force feedback apparatus 100 is powered on for the first time, the driving assembly 3 drives the second transmission end to rotate, so that the trigger 2 is in a preset initial position relative to the base 1.

An embodiment of this application further discloses an electronic device. The electronic device includes the force feedback apparatus 100 in any one of the foregoing embodiments. When the force feedback apparatus 100 in any one of the foregoing embodiments is applied to the electronic device, tactile feedback such as damping, force release, vibration, and rebound may be implemented through the trigger 2. The tactile feedback is precisely fed back to a user through the trigger 2, thereby improving a real sense and accuracy of the tactile feedback.

The electronic device disclosed in this embodiment of this application may be a device such as a smartphone, a tablet computer, an eBook reader, a wearable device (for example, a smartwatch), or an electronic game console. A specific type of the electronic device is not limited in this embodiment of this application.

The apparatus embodiment described above is merely an example. The units described as separate components may or may not be physically separate, and the components displayed as units may or may not be physical units. They may be located in one place, or may be distributed over a plurality of network units. Some or all of the modules may be selected based on an actual need to achieve the objectives of the solutions of embodiments. A person of ordinary skill in the art may understand and implement embodiments without creative efforts.

The term "one embodiment", "an embodiment", or "one or more embodiments" mentioned herein means that specific features, structures, or characteristics described in combination with the embodiment are included in at least one embodiment of this application. In addition, it should be noted that the word examples "in an embodiment" do not necessarily refer to a same embodiment.

Numerous specific details are set forth in the specification provided herein. However, it may be understood that, embodiments of this application may be practiced without the specific details. In some examples, known methods, structures, and technologies are not disclosed in detail, so as avoid obscuring understanding on this specification.

In the claims, any reference signs located between parentheses shall not be construed as a limitation on the claims. The word "include" does not exclude elements or steps that are not listed in the claims. The word "a" or "one" before an element does not exclude a plurality of such elements. This application may be implemented through hardware including different elements and a properly programmed computer. In the unit claims enumerating a plurality of apparatuses, some of these apparatuses may be specifically embodied by the same item of hardware. The use of the words such as "first", "second", and "third" does not represent any order. These words may be interpreted as names.

It should be finally noted that the foregoing embodiments are merely used to describe the technical solutions of this application, and are not used to limit this application. Although this application is described in detail with reference to the foregoing embodiments, a person of ordinary skill in the art is to understand that modifications may still be made to the technical solutions described in the foregoing embodiments or equivalent replacements may be made to some technical features thereof, as long as such modifications or replacements do not cause the essence of corresponding technical solutions to depart from the spirit and scope of the technical solutions of embodiments of this application.

What is claimed is:

1. A force feedback apparatus, comprising:
a base;
a trigger, rotatably connected to the base;
a first transmission assembly, in a transmission-connection to the trigger;
a second transmission assembly, comprising a first gear, a transmission gear, a ring gear, and a rotatable support, wherein the transmission gear is meshed between the first gear and the ring gear, the ring gear is fixed to the base, the rotatable support is connected to the transmission gear, the rotatable support is rotatable relative to the first gear and the ring gear, one of the rotatable support and the first gear is a first transmission end of the second transmission assembly, the other of the rotatable support and the first gear is a second transmission end of the second transmission assembly, and the first transmission end is in the transmission-connection to the first transmission assembly; and
a driving assembly, in the transmission-connection to the second transmission end, wherein the driving assembly is configured to drive the second transmission end to rotate; and
when the trigger rotates relative to the base, the trigger is configured to drive, through the first transmission assembly, the first transmission end to rotate, and the driving assembly is configured to drive the second transmission end to rotate, to block or assist in rotation of the first transmission end.

2. The force feedback apparatus according to claim 1, wherein the first transmission end is the rotatable support, the second transmission end is the first gear, and the first transmission assembly, the rotatable support, the first gear, and the driving assembly are sequentially arranged along a first direction.

3. The force feedback apparatus according to claim 2, wherein the base has a first opening and a second opening provided along the first direction, the second transmission assembly is arranged in the base, a portion of the rotatable support extends out of the base through the first opening and is connected to the first transmission assembly, and a portion of the driving assembly extends into the base through the second opening and is connected to the first gear.

4. The force feedback apparatus according to claim 3, wherein the base comprises a first cover and a second cover that are combined along the first direction, the first opening is provided on the first cover, the second opening is provided on the second cover, and the ring gear is fixed to the first cover or the second cover.

5. The force feedback apparatus according to claim 4, wherein the ring gear is fixed to the second cover, the first cover comprises a cover plate and a side plate arranged on the cover plate, the second cover is arranged to cover the side plate, and the side plate surrounds an outer side of the ring gear.

6. The force feedback apparatus according to claim 1, wherein the rotatable support comprises a mounting plate, a first connection bar, and a second connection bar, the mounting plate comprises two sides along a first direction, the first connection bar and the second connection bar are connected to the two sides of the mounting plate, the first connection bar extends out of the base and is connected to the first transmission assembly, and the second connection bar is connected to the transmission gear.

7. The force feedback apparatus according to claim 1, wherein the transmission gear includes a plurality of transmission gears, the plurality of transmission gears are arranged around the first gear, and the rotatable support is connected to the plurality of transmission gears.

8. The force feedback apparatus according to claim 7, wherein the ring gear comprises a plurality of arc-shaped racks and limiting pieces arranged on two ends of the arc-shaped racks, the plurality of arc-shaped racks are sequentially arranged around the first gear at intervals, and the plurality of transmission gears are meshed with the plurality of arc-shaped racks in one-to-one correspondence.

9. The force feedback apparatus according to claim 1, wherein the first transmission assembly comprises:
a swinging arm, having one end rotatably connected to the trigger, wherein the trigger is configured to drive the swinging arm to rotate relative to the base; and
a second gear, connected to the first transmission end and meshed with the swinging arm, wherein the second gear, the second transmission assembly, and the driving assembly are sequentially connected along a first direction, the second transmission assembly and the trigger are spaced apart along a second direction, and the first direction intersects the second direction.

10. The force feedback apparatus according to claim 1, further comprising:
a detection mechanism, comprising a first sensor and a second sensor, wherein one of the first sensor and the second sensor are arranged on the first transmission assembly, the other of the first sensor and the second sensor is arranged on the base, and when the trigger rotates relative to the base between a first position and a second position, the first sensor moves away from or approaches the second sensor, and the first sensor is configured to generate relative position information of the first sensor and the second sensor; and
a control mechanism, electrically connected to the driving assembly and the first sensor, wherein the control mechanism is configured to control, based on the relative position information, the driving assembly to drive the second transmission end to rotate.

11. The force feedback apparatus according to claim 1, wherein the force feedback apparatus has at least one of a first operating mode, a second operating mode, or a third operating mode;
when the force feedback apparatus is in the first operating mode, the driving assembly drives the second transmission end to rotate, for the trigger to rotate back and forth relative to the base between a first position and a second position;
when the force feedback apparatus is in the second operating mode and the trigger rotates relative to the base between the first position and the second position, the trigger drives, through the first transmission assembly, the first transmission end to rotate along a first circumferential direction, and the driving assembly drives the second transmission end to rotate along the first circumferential direction; and
when the force feedback apparatus is in the third operating mode and the trigger rotates relative to the base between the first position and the second position, the trigger drives, through the first transmission assembly, the first transmission end to rotate in the first circumferential direction, and the driving assembly drives the second transmission end to rotate along a second circumferential direction,
wherein the first circumferential direction and the second circumferential direction are opposite directions.

12. An electronic device, comprising:
a force feedback apparatus, comprising:
a base;
a trigger, rotatably connected to the base;
a first transmission assembly, in a transmission-connection to the trigger;
a second transmission assembly, comprising a first gear, a transmission gear, a ring gear, and a rotatable support, wherein the transmission gear is meshed between the first gear and the ring gear, the ring gear is fixed to the base, the rotatable support is connected to the transmission gear, the rotatable support is rotatable relative to the first gear and the ring gear, one of the rotatable support and the first gear is a first transmission end of the second transmission assembly, the other of the rotatable support and the first gear is a second transmission end of the second transmission assembly, and the first transmission end is in the transmission-connection to the first transmission assembly; and
a driving assembly, in the transmission-connection to the second transmission end, wherein the driving assembly is configured to drive the second transmission end to rotate; and
when the trigger rotates relative to the base, the trigger is configured to drive, through the first transmission assembly, the first transmission end to rotate, and the driving assembly is configured to drive the second transmission end to rotate, to block or assist in rotation of the first transmission end.

13. The electronic device according to claim 12, wherein the first transmission end is the rotatable support, the second transmission end is the first gear, and the first transmission assembly, the rotatable support, the first gear, and the driving assembly are sequentially arranged along a first direction.

14. The electronic device according to claim 13, wherein the base has a first opening and a second opening provided along the first direction, the second transmission assembly is arranged in the base, a portion of the rotatable support extends out of the base through the first opening and is connected to the first transmission assembly, and a portion of the driving assembly extends into the base through the second opening and is connected to the first gear.

15. The electronic device according to claim 14, wherein the base comprises a first cover and a second cover that are combined along the first direction, the first opening is provided on the first cover, the second opening is provided on the second cover, and the ring gear is fixed to the first cover or the second cover.

16. The electronic device according to claim 15, wherein the ring gear is fixed to the second cover, the first cover comprises a cover plate and a side plate arranged on the cover plate, the second cover is arranged to cover the side plate, and the side plate surrounds an outer side of the ring gear.

17. The electronic device according to claim 12, wherein the rotatable support comprises a mounting plate, a first connection bar, and a second connection bar, the mounting plate comprises two sides along a first direction, the first connection bar and the second connection bar are connected to the two sides of the mounting plate, the first connection bar extends out of the base and is connected to the first transmission assembly, and the second connection bar is connected to the transmission gear.

18. The force feedback apparatus according to claim 12, wherein the transmission gear includes a plurality of transmission gears, the plurality of transmission gears are arranged around the first gear, and the rotatable support is connected to the plurality of transmission gears.

19. The electronic device according to claim 12, wherein the first transmission assembly comprises:
a swinging arm, having one end rotatably connected to the trigger, wherein the trigger is configured to drive the swinging arm to rotate relative to the base; and
a second gear, connected to the first transmission end and meshed with the swinging arm, wherein the second gear, the second transmission assembly, and the driving assembly are sequentially connected along a first direction, the second transmission assembly and the trigger are spaced apart along a second direction, and the first direction intersects the second direction.

20. The electronic device according to claim 12, further comprising:
a detection mechanism, comprising a first sensor and a second sensor, wherein one of the first sensor and the second sensor are arranged on the first transmission assembly, the other of the first sensor and the second sensor is arranged on the base, and when the trigger rotates relative to the base between a first position and a second position, the first sensor moves away from or approaches the second sensor, and the first sensor is configured to generate relative position information of the first sensor and the second sensor; and
a control mechanism, electrically connected to the driving assembly and the first sensor, wherein the control mechanism is configured to control, based on the relative position information, the driving assembly to drive the second transmission end to rotate.
